(19) United States
(12) Patent Application Publication
(10) Pub. No.: US 2008/0284171 A1
(43) Pub. Date: Nov. 20, 2008

(54) Augmented wind power generation system using an antecedent atmospheric sensor and method of operation

(75) Inventor: Kenneth D. Cory, Carrollton, TX (US)

Correspondence Address: DOCKET CLERK, P.O. DRAWER 800889, DALLAS, TX, 75380, US

(73) Assignee: V3 Technologies, L.L.C., Dallas, TX (US)

(21) Appl. No.: 11/803,924

(22) Filed: May 16, 2007

(51) Int. Cl. F03D 9/00; H02P 9/04

(52) U.S. Cl. 290/44; 290/55

(57) ABSTRACT

A wind power generating apparatus is provided. The apparatus includes a plurality of vertically stacked wind acceleration modules. The apparatus further includes a rotor assembly, an electrical generator mechanically coupled to the rotor assembly, and a sensor in communication with the electrical generator. The sensor is capable of sensing a characteristic of wind prior to the wind reaching the rotor assembly and the electrical generator is capable of adjusting its operation according to the wind characteristic sensed by the sensor. The sensor may be coupled to a controller, which may control the operation of the electrical generator according to a signal from the sensor. The electrical generator may include a continuously variable transmission and the controller may adjust the ratio of the rotational speeds of the transmission input and output according to the sensed wind characteristic.

### TECHNICAL FIELD OF THE INVENTION

The present application relates generally to electrical power generation and, more specifically, to an apparatus and method for generating electrical power from wind.

### BACKGROUND OF THE INVENTION

The environmental costs of fossil fuels and the political instabilities of oil-producing regions have intensified efforts to develop alternative energy sources that are environmentally clean and more reliable. Wind-driven power generation systems are of particular interest. Wind power may be converted to electrical power using a rotor assembly, either horizontally or vertically oriented. The rotor blades convert the energy of the moving air into a rotational motion of a drive shaft. An electrical generator coupled to the drive shaft then converts the rotational motion into electrical power. Typically, a fixed-ratio gear box converts the low rotation speed of the rotor assembly to a higher rotation speed for the electrical generator.

A conventional wind-driven power generation system is typically a monopole tower with a single rotor rotating about a hub located at or near the top of the tower. The tower produces power only when the wind blows, only within a certain range of wind velocities, and at a maximum power output level for an even smaller range of wind velocities. As a result, wind power generation has traditionally been expensive to produce and not reliably available. In response, conventional wind turbine manufacturers' designs have evolved towards very large rotor assemblies and very tall towers in order to gain economies of scale and to reach higher velocity and steadier winds at higher altitudes.

However, a larger rotor assembly rotates more slowly than a smaller rotor assembly and requires a higher gear ratio to provide an optimal rotational speed range for the electrical generator. A larger rotor assembly also has a greater mass, requiring stronger winds to cause rotation. Furthermore, a larger rotor assembly applies greater torque stress to a gear box, requiring that the gear box be larger in size and made of more exotic and expensive materials. Finally, even with exotic materials and sturdier supports, a larger rotor assembly is still limited to a lower maximum wind speed at which the rotor assembly can operate without causing damage to the mechanical components of the wind tower.

An augmented wind power generation system uses a funneling apparatus, for example a fully or partially shrouded rotor, to increase the velocity of the ambient wind across a smaller rotor assembly. Such funneling apparatuses may be vertically stacked into a tower with one or more rotor assemblies located in each apparatus. Such wind amplification devices are described in U.S. Pat. No. 4,156,579 (Weisbrich), U.S. Pat. No. 4,288,199 (Weisbrich), U.S. Pat. No. 4,332,518 (Weisbrich), U.S. Pat. No. 4,540,333 (Weisbrich), and U.S. Pat. No. 5,520,505 (Weisbrich). All five Weisbrich patents are hereby incorporated by reference as if fully set forth herein.

The wind speed amplification effect of the funnel permits power generation to occur at lower ambient wind speeds. Specifically, because the electrical power generated from wind is a cubic function of the wind's velocity, a smaller rotor assembly can generate similar amounts of power to a larger rotor with an equal amount of ambient wind. In other words, the rotor assemblies of an augmented wind power generation system are typically smaller than those in a traditional wind tower, and therefore have a smaller mass and higher rotational speeds.

Conventional wind-driven power generation systems, both towers and augmented systems, cannot operate in wind above a maximum speed, due to mechanical stresses on the components of the systems when operating at too high a speed. In addition, a sudden increase in wind speed may cause such a system to operate outside safe limits for a brief period of time before adjustments take effect and return the system to operation within safe limits. While such periods may be brief, their repeated occurrence may result in cumulative damage to the system.

As a result, wind turbine manufacturers have sought improvements whereby their generators could better adapt to high winds or wind gusts. First, there have been significant improvements in variable speed synchronous generators that do not necessarily require a gear box but do typically require a controller mechanism to adjust the speed of rotation of the magnetic forces in the generator. Still, these generators do not yet work well with large bladed rotors which rely on the more traditional induction, or asynchronous, generator. This generator turns at higher rotational speeds and typically requires a gear box to speed up the speed of the shafts leading from the wind turbines. Some efforts are being made to make cost effective induction generators that are variable speed, but substantial improvement is needed before such a generator gains significant market share.

In general, a tower system is typically constructed as a rotor mounted to the front of a nacelle that houses a gear box and generator. The nacelle is rotatably mounted at or near the top of the tower. Wind speed sensors for use in preventing the tower system from operating outside its safe limits have traditionally been mounted in or on the nacelle. As such, they detect wind speed after the wind has already acted on the rotor. Furthermore, the wind speed sensed is no longer that of the ambient wind, but rather that of wind that has passed through the rotor. No technique has been developed to mount a sensor on a tower system such that the sensor is in front of the rotor and remains in front of the rotor as the nacelle rotates to keep the rotor facing into the wind.

Sensing true ambient wind speed at a tower system is also difficult due to the large size of rotors in use. Wind velocity typically varies with altitude. A rotor on a typical tower system may have a diameter of 250 feet or more and be subject to winds of a variety of speeds across its diameter. As a result, an array of sensors across the face of the rotor would be required in order to effectively adjust components of the tower system to prevent operation outside safe limits.

Therefore, there is a need in the art for an improved apparatus and method for generating electrical power from wind.

### SUMMARY OF THE INVENTION

A wind power generating apparatus is provided. The apparatus includes a plurality of vertically stacked wind acceleration modules that are shaped to accelerate wind passing between them. At least one of the modules includes a rotor assembly, an electrical generator mechanically coupled to the rotor assembly, and a sensor in communication with the electrical generator. The electrical generator is capable of converting mechanical energy from the rotor assembly into electrical energy. The sensor is capable of sensing a characteristic of wind prior to the wind impinging upon the rotor assembly and the electrical generator is capable of adjusting its operation according to the wind characteristic sensed by the sensor.

A method for generating power from wind is provided, for use with a plurality of vertically stacked wind acceleration modules. The method includes transmitting mechanical energy from a rotor assembly mounted in one of the modules to an electrical generator. The method also includes sensing a characteristic of wind prior to the wind impinging upon the rotor assembly and, according to the sensed characteristic, adjusting an operational characteristic of the electrical generator. The method further includes generating electrical energy with the electrical generator.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an augmented wind power generation system according to the disclosure;

FIG. 2 illustrates a schematic view of an embodiment of the disclosure;

FIG. 3 presents illustrative power curves of a current wind power generation system and an augmented wind power generation system according to the disclosure;

FIG. 4 presents a sectional view taken along line A-A in FIG. 1;

FIG. 5 depicts a sectional view taken along line B-B in FIG. 4; and

FIG. 6 presents a schematic view of another embodiment of the disclosure.

### DETAILED DESCRIPTION OF THE INVENTION

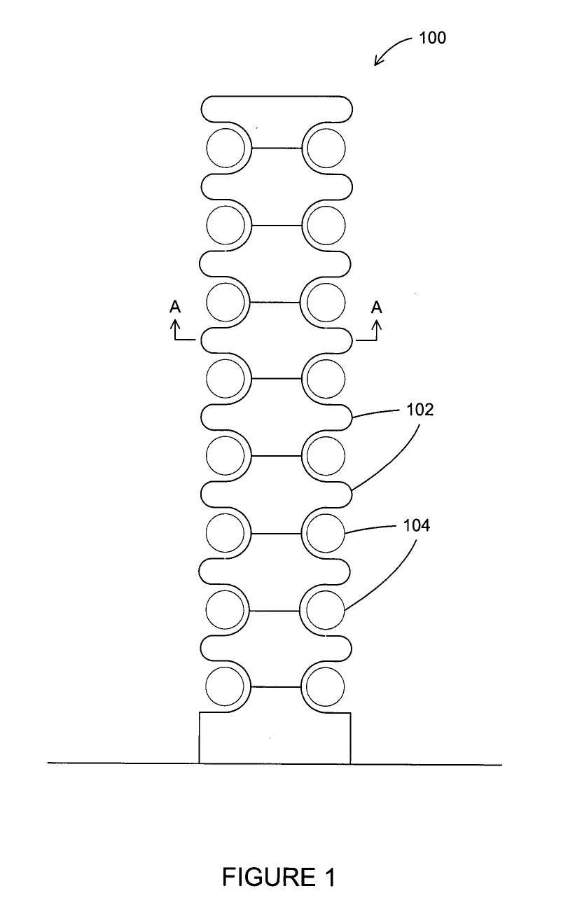

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged augmented wind power generation system.

FIG. 1 illustrates an augmented wind power generation system 100 according to the disclosure. The system 100 comprises an internal central tower (not shown in FIG. 1) and a plurality of preferably stationary vertically stacked wind acceleration modules 102. The modules 102 are shaped to create semi-toroidal hollows around the tower. That is, the modules are substantially circularly symmetrical about a vertical axis, having an outer surface contour as shown in FIG. 1. The shape of modules 102 has the effect of increasing the velocity of wind flowing around the tower through the hollows in the modules. Rotor assemblies 104 may be located in the exterior hollows of one or more of the modules 102 to convert kinetic energy of wind flowing through the hollows into rotational energy of the rotor assemblies 104.

Typically, pairs of the rotor assemblies 104 are located in the hollows on opposite sides of the system 100, in order to convert the energy of the wind flowing around both sides of the system 100 into rotational energy. Furthermore, the pairs of rotor assemblies 104 are typically rotationally mounted to the central tower to permit the rotor assemblies 104 to adapt to changes in wind direction by rotating around the system 100 to face into the wind. The rotation of a pair of the rotor assemblies 104 in one semi-toroidal hollow may be independent of the rotation of a pair of the rotor assemblies 104 in another of the semi-toroidal hollows, enabling the system 100 to adapt to wind from differing directions at different heights of the system 100. The height of system 100 may be measured in hundreds of feet and wind direction may be substantially different at ground level than at higher elevations.

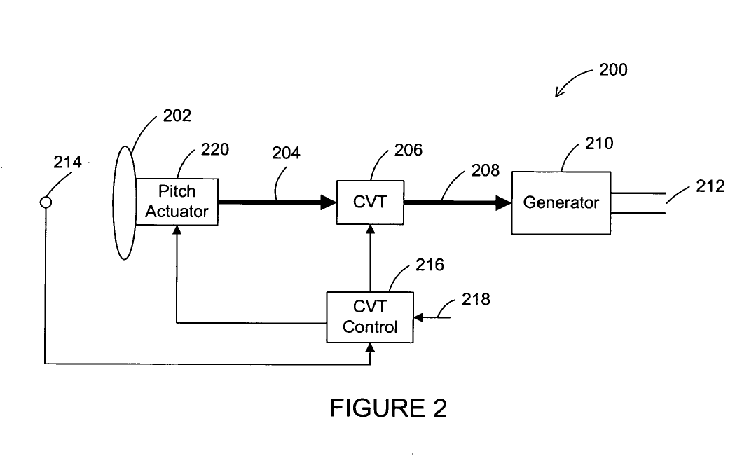

FIG. 2 illustrates a schematic view of an apparatus 200 according to the disclosure. A rotor assembly 202 is mechanically coupled by a first drive shaft 204 to a power input of a continuously variable transmission (CVT) 206. A power output of the CVT 206 is mechanically coupled by a second drive shaft 208 to an electrical generator 210. The electrical generator 210 converts rotational mechanical energy into electrical energy on conductors 212. In this way, kinetic energy of wind impinging upon the rotor assembly is converted into rotational mechanical energy of the first drive shaft 204, which is transmitted by the CVT 206 to the second drive shaft 208 and thence to the electrical generator 210, where it is converted into electrical energy.

A transmission transmits mechanical power applied to an input drive shaft to an output drive shaft. Typically, rotational speed of the output is different than that of the input. In a conventional wind power generator, a transmission comprising a fixed ratio gear box couples a low speed rotor assembly to a high speed electrical generator. In a vehicle, a transmission providing a fixed number of discrete gear ratios typically couples a high speed engine to low speed wheels. A CVT is characterized by providing a continuous range of ratios of input rotational speed to output rotational speed.

Continuously variable transmissions are widely known and understood. A CVT may comprise a pair of pulleys coupled by a belt, wherein the diameter of one or both pulleys may be varied. As the diameter of either or both pulleys is smoothly varied, the ratio of the rotational speeds of the input shaft and the output shaft varies smoothly. A CVT may alternatively comprise conical members coupled to the input and output shafts. A belt or roller may be coupled to both cones and transmit the rotational motion of the input cone to the output cone. If the cones are oriented so that their axes of rotation are parallel and the wide end of one cone is adjacent to the narrow end of the other cone, then movement of the belt or roller in the direction of the axes of rotation provides a continuous variation in the rotational speed ratio between the input shaft and output shaft.

Some types of CVTs are also known as infinitely variable transmissions (IVTs). An IVT may allow for an greater number of possible gear ratios and may be metal to metal rather than using traditional belts or rollers to transfer power.

The apparatus 200 may also comprise a sensor 214 located to sense a characteristic of wind impinging on the rotor assembly 202. The sensor 214 may generate a digital output signal indicating the velocity, temperature, humidity or other characteristic of the wind. A controller 216 may be electrically coupled to the sensor 214 to receive the digital output signal. The controller 216 may also be electrically coupled to the CVT 206 to control its gear ratio. In this way, the controller 216 may control the CVT 206 according to the signal representing the sensed wind characteristic received from the sensor 214 in order to operate the electrical generator 210 in a desired range of rotational velocities. The desired range of velocities may be determined by a control signal input 218 to the controller 216.

While FIG. 2 depicts an apparatus having a sensor 214 measuring a characteristic of the wind impinging on the rotor assembly 202, in other embodiments additional sensors may be used. In another embodiment a tachometer measuring the rotational velocity of first drive shaft 204 may provide an electrical speed signal for use by the controller 216 in controlling the CVT 206. In a further embodiment a tachometer measuring the rotational velocity of second drive shaft 208 may provide an electrical speed signal to the controller 216. In yet another embodiment, tachometers may be employed to measure the rotational velocities of both first drive shaft 204 and second drive shaft 208.

There may be an upper limit on the rotational velocity at which mechanical components of the apparatus 200 (such as the CVT 206, the electrical generator 210, or bearings supporting the drive shafts 204 or 208) may operate without experiencing excessive wear or mechanical failure. Where the components at risk are the second drive shaft 208 or the electrical generator 210, rotational velocity may be kept under the upper limit through the operation of the CVT 206.

However, in other situations a rotational speed ratio limit of the CVT 206 may prevent it from keeping the rotational velocity of the second drive shaft 208 or the electrical generator 210 under the upper limit. In still other situations the components at risk may be the first drive shaft 204 or the CVT 206 itself. In such situations, the apparatus 200 may also comprise a pitch actuator 220, electrically coupled to the controller 216. The pitch actuator 220 operates to change the pitch of blades in the rotor assembly 202 in order to reduce the rotational velocity of the rotor assembly 202 at a given wind velocity. In this way, as rotational velocities of components of the apparatus 200 approach an upper limit, the controller 216 may change the pitch of blades in the rotor assembly 202 in order to prevent rotational velocities from exceeding the upper limit.

At still higher wind velocities rotation of the rotor assembly may be prevented. In such situations, the blades of the rotor assembly may be turned edge-on to the wind to minimize torque generated in the rotor assembly. In another embodiment, the entire rotor assembly may be rotated in a substantially horizontal plane to a position in which it does not fully engage the wind-for example, a position where the wind impinges upon the rotor assembly from the side, rather than from the front. Furthermore, the CVT 206 or a separate brake (not shown in FIG. 2) may be used to prevent rotation of the drive shafts 204 and 208. In another embodiment, the drive shaft 204 may remain free to rotate while the drive shaft 208 is prevented from rotating by putting the CVT 206 into ‘neutral’-that is, a condition in which the drive shaft 208 is decoupled from the drive shaft 204.

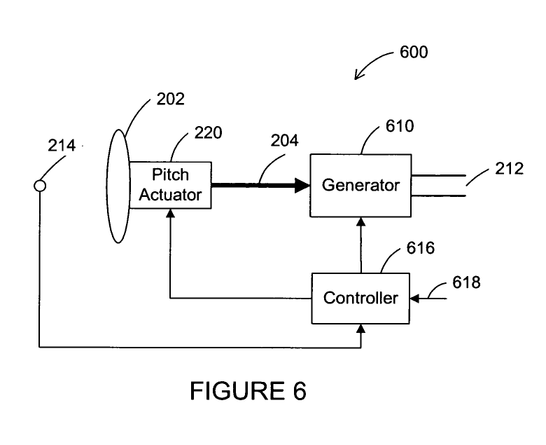

FIG. 6 presents a schematic view of another apparatus 600 according to the disclosure. In apparatus 600, a generator 610 may be coupled directly to rotor assembly 202 via drive shaft 204 rather than via CVT 206, as in apparatus 200. A controller 616 may be used to provide signals to the generator 610 to achieve a constant output of electricity from an input shaft rotating at varying speeds. For example in a Variable Speed Generator (“VSG”), such as a synchronous generator, a controller 616 may vary the rotational speed of magnetic flux to control the operation of the generator 610. An external control signal 618 may still provide control parameters to the controller 616. Furthermore, the controller 616 may also control the operation of a pitch 220 in order to maintain the rotational velocity of the drive shaft 204 within safe operational limits of the generator 610, as described with reference to apparatus 200.

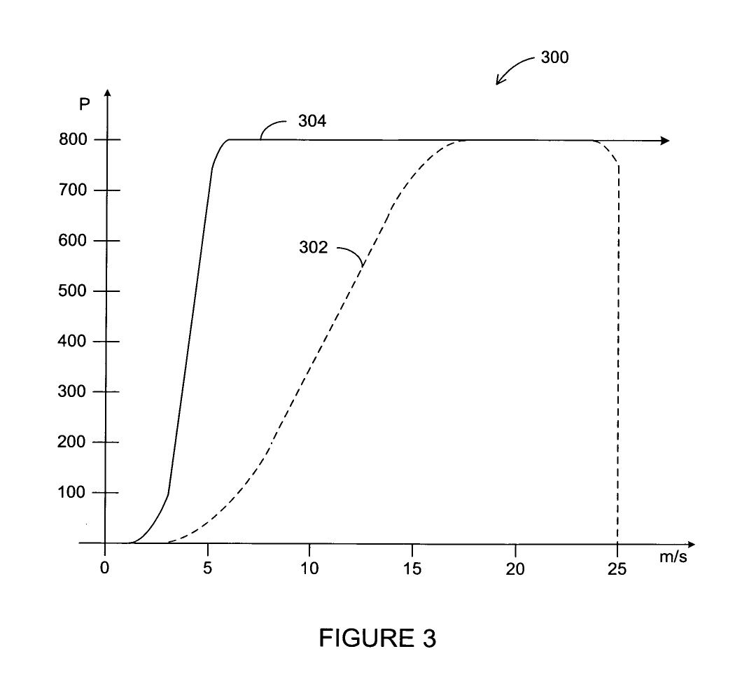

FIG. 3 presents illustrative power curves of a traditional wind power generation system and an augmented wind power generation system according to the disclosure. Ambient wind speed is plotted along the horizontal axis and generated electrical power along the vertical axis.

An exemplary power curve for a traditional wind tower or conventional augmented wind power generation system is shown by dashed line 302. For wind speeds below a so-called cut-in wind speed of about 4 meters per second (m/s) the depicted system generates no electrical power. For wind speeds between about 4 m/s and 15 m/s an amount of electrical power proportional to the wind speed is generated. For wind speeds between about 15 m/s to 25 m/s the amount of power generated is substantially constant. The depicted system has a so-called cut-out wind speed of 25 m/s. Allowing a system to operate in winds above its cut-out speed may damage system components, so a system is typically braked or its rotor blades turned edge-on to the wind to minimize torque on the system.

In contrast, an augmented wind power generation system according to the present disclosure, such as that shown in FIG. 2, produces electrical power over a greater range of wind speeds, as may be seen in solid line 304. The CVT 206 may adjust or be adjusted to permit the electrical generator 210 to operate at or near an optimal rotational velocity for a broader range of wind speeds than a traditional wind tower or conventional augmented wind power generation system. A system of the present disclosure may begin generating power at a lower cut-in wind speed. For wind speeds from the cut-in velocity to a cut-out velocity (not shown in FIG. 3) the effective gear ratio of the CVT 206 may be adjusted to generate a constant level of electrical power.

A traditional wind tower or conventional augmented wind power generation system has a fixed ratio gear box designed to allow an electrical generator to operate in an optimal range of rotational speeds when wind speed is in a range typical for the site at which the system is installed. Such a gear box typically provides a step up in speed from the rotational velocity of the rotor assembly to that of the electrical generator, regardless of the wind speed. This design results in the electrical generator being ‘over rotated’ in winds above a certain speed-which determines the cut-out speed of such a traditional system.

In contrast, the CVT 206 may provide a step up in rotational velocity at lower wind speeds and a step down at higher wind speeds, allowing the electrical generator 210 to operate over a broader range of wind speeds. As described with regard to FIG. 2, however, an upper limit of wind speed may still exist for an augmented wind power generation system according to the present disclosure above which such a system should not be operated.

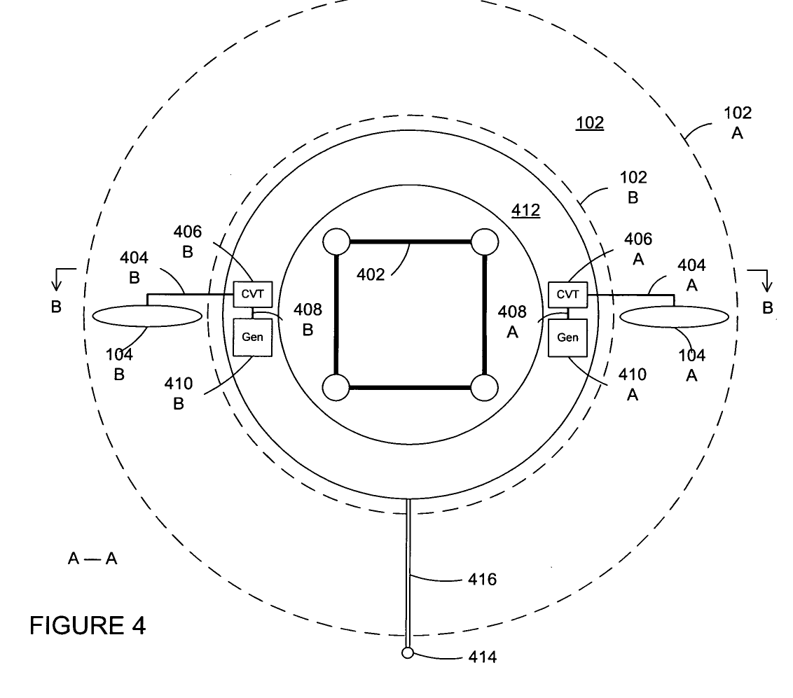

FIG. 4 presents a sectional view taken along line A-A in FIG. 1. The wind acceleration module 102 is mounted to a central tower 402. Dashed line 102A indicates an outermost extent of the contour of the module 102 and dashed line 102B indicates an innermost extent of the semi-toroidal hollow of the module 102. The rotor assemblies 104A and 104B are located within the semi-toroidal hollow of the module 102, as described with regard to FIG. 1.

Mechanically coupled to the rotor assembly 104A is a first drive shaft 404A, which is also mechanically coupled to a power input of a CVT 406A. A power output of the CVT 406A is mechanically coupled to a second drive shaft 408A, which is also mechanically coupled to an electrical generator 410A. Drive shaft 404B, CVT 406B, drive shaft 408B, and electrical generator 410B are similarly coupled to the rotor assembly 104B. Both sets of components are mounted on a platform 412, which is rotatably mounted to the central tower 402. Note that drive shafts 404A and 404B extend through one or more horizontal gaps in the wind acceleration module 102.

Also mounted to the platform 412 is a mast 416 with an attached sensor 414. In the embodiment shown in FIG. 4, the sensor 414 is located so that it senses characteristics of the wind before the wind reaches the wind acceleration module 102; that is, it is positioned antecedent to the rotor assemblies 104A and 104B. It will be understood that in other embodiments the sensor 414 may be located within the semi-toroidal hollow of the section 102, to sense characteristics of the wind after its acceleration by the section 102. In still other embodiments, a plurality of sensors 414 may be located in a plurality of positions to sense characteristics of the wind in multiple locations prior to the wind impinging upon rotor assemblies 104A and 104B.

Because the platform 412 may rotate about the central tower 402, when the direction of the wind changes the platform 412 may be repositioned so that the sensor 414 and the rotor assemblies 104A and 104B face into the wind. In this new position, the electrical generators 410A and 410B may generate more electrical power than in a previous position.

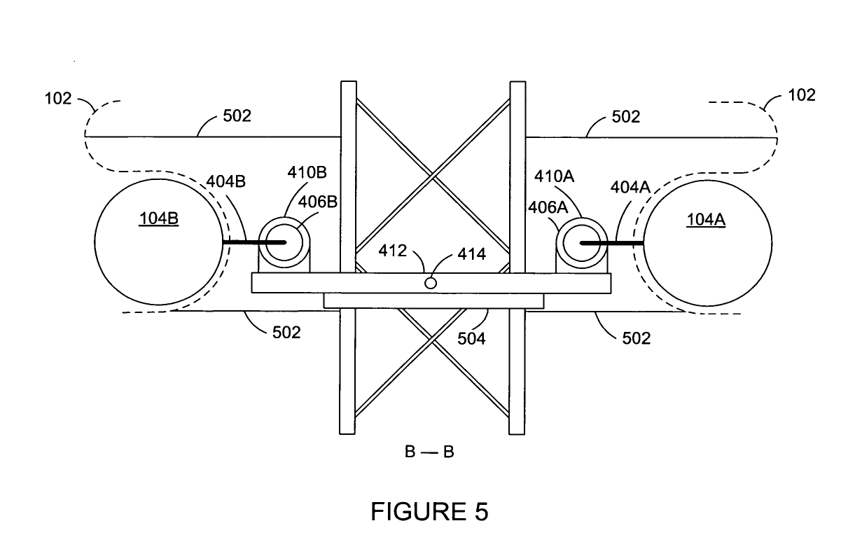

FIG. 5 depicts a sectional view taken along line B-B in FIG. 4. The contour of the wind acceleration module 102 is depicted with dashed lines. The module 102 is mounted to the central tower 402 by struts 502. It may be seen that a second module 102 may be mounted to the central tower 402 below the first module 102, shown in FIG. 5, such that the upper portion of the second module 102 and the lower portion of the first module 102 mate to produce a substantially unbroken surface.

As described with regard to FIG. 4, the rotor assembly 104A, the drive shaft 404A, the CVT 406A and the electrical generator 410A are mounted on one side of the platform 412. The comparable components mechanically coupled to the rotor assembly 104B are mounted to the other side of the platform 412. Also mounted to the platform 412 is the sensor 414. The platform 412 is rotatably mounted to the central tower 402 by a bearing assembly 504. A wiring harness or other electrical coupling system (not shown in FIG. 5) may be used to combine into a single output the electrical power produced by the electrical generators 104A and 104B and generators in other wind acceleration modules.

Although the present disclosure has been described with an exemplary embodiment, various changes and modifications may be suggested to one skilled in the art. For example, in another embodiment, a conventional wind-driven power generation system having a single rotor rotating about a hub located at or near the top of the tower may employ a CVT to couple the rotor to an electrical generator. In yet another embodiment, an augmented wind power generation system having a different wind funneling apparatus than that shown in FIG. 1 may be used. In still another embodiment, such an augmented wind power generation system may include only a single rotor assembly, which may be fully shrouded, rather than partially shrouded, as shown in FIG. 1. It is intended that the present disclosure encompass such changes and modifications as fall within the scope of the appended claims.

What is claimed is:

1. A wind power generating system, comprising a plurality of vertically stacked wind acceleration sections shaped to accelerate wind passing through the sections, wherein a first one of the plurality of sections comprises:
a rotor assembly;
an electrical generator mechanically coupled to the rotor assembly and capable of converting mechanical energy from the rotor assembly into electrical energy; and
a sensor communicatively coupled to the electrical generator, the sensor capable of sensing a characteristic of wind prior to the wind impinging upon the rotor assembly,
wherein the electrical generator is further capable of adjusting its operation according to the sensed characteristic.

2. The system of claim 1, further comprising a controller electrically coupled to the sensor and to the electrical generator, wherein the controller is capable of adjusting the operation of the electrical generator according to a signal received from the sensor.

3. The system of claim 1, wherein:
the electrical generator comprises a continuously variable transmission (CVT) mechanically coupling the electrical generator to the rotor assembly;
the sensor is communicatively coupled to the CVT; and
the CVT is further capable of adjusting its operation according to the sensed characteristic.

4. The system of claim 3, further comprising a controller electrically coupled to the sensor and to the CVT, wherein the controller is capable of adjusting the operation of the CVT according to a signal received from the sensor.

5. The system of claim 4, wherein the controller is further capable of adjusting the operation of the CVT according to the signal received from the sensor such that the electrical generator operates within a predetermined range of rotational velocities.

6. The system of claim 4, wherein the controller is further capable of preventing rotation of the electrical generator according to the signal received from the sensor.

7. The system of claim 4, wherein the rotor assembly further comprises a pitch control mechanism electrically coupled to the controller and the controller is further capable of controlling a pitch of the rotor assembly according to the signal received from the sensor.

8. The system of claim 3, wherein:
the rotor assembly, CVT, electrical generator, and sensor are mounted on a platform; and
the platform is capable of rotation about a substantially vertical axis in response to a change in wind direction.

9. The system of claim 8, wherein:
the first one of the plurality of sections further comprises a second rotor assembly, CVT and electrical generator mounted on the platform;
the second CVT is communicatively coupled to the sensor and is further capable of adjusting its operation according to the sensed characteristic.

10. A method of generating electrical power from wind, for use with a plurality of vertically stacked wind acceleration sections, the method comprising:
transmitting mechanical energy from a rotor assembly mounted in one of the plurality of sections to an electrical generator;
sensing a characteristic of wind prior to the wind impinging upon the rotor assembly;
adjusting an operational characteristic of the electrical generator according to the sensed characteristic; and
generating electrical energy with the electrical generator.

11. The method of claim 10, wherein:
the electrical generator comprises a transmission having an input coupled to the rotor assembly and an output coupled to the electrical generator; and
adjusting an operational characteristic of the electrical generator comprises varying a ratio of the rotational speed of the transmission input to the rotational speed of the transmission output over a continuous range of values.

12. The method of claim 11, wherein varying the ratio further comprises varying the ratio according to the sensed characteristic such that the electrical generator operates within a predetermined range of rotational speeds.

13. The method of claim 11, further comprising preventing transmission of mechanical energy from the rotor assembly to the rotating electrical generator according to the sensed characteristic.

14. The method of claim 11, further comprising controlling a pitch of the rotor assembly according to the sensed characteristic.

15. The method of claim 11, wherein the one of the plurality of sections is substantially circularly symmetrical about a vertical axis and the method further comprises moving the rotor assembly within the section along a circular path concentric with the axis of symmetry of the section.

16. The method of claim 15, wherein the rotor assembly and electrical generator are mounted on a platform, the method further comprising rotating the platform about a tower from a first position to a second position, wherein the electrical energy generated by the electrical generator in the second position is greater than the electrical energy generated by the electrical generator in the first position.

17. A wind power generating apparatus, comprising:
a rotor assembly;
an electrical generator mechanically coupled to the rotor assembly and capable of converting mechanical energy from the rotor assembly into electrical energy; and
a sensor communicatively coupled to the electrical generator, the sensor capable of sensing a characteristic of wind prior to the wind impinging upon the rotor assembly,
wherein the electrical generator is further capable of adjusting its operation according to the sensed atmospheric characteristic.

18. The apparatus of claim 17, further comprising a controller electrically coupled to the sensor and to the electrical generator, wherein the controller is capable of adjusting the operation of the electrical generator according to a signal received from the sensor.

19. The apparatus of claim 17, wherein:
the electrical generator comprises a continuously variable transmission (CVT) mechanically coupling the electrical generator to the rotor assembly;
the sensor is communicatively coupled to the CVT; and
the CVT is further capable of adjusting its operation according to the sensed characteristic.

20. The apparatus of claim 19, further comprising a controller electrically coupled to the sensor and to the CVT, wherein the controller is capable of adjusting the operation of the CVT according to a signal received from the sensor.

21. The apparatus of claim 20, wherein the controller is further capable of adjusting the operation of the CVT according to the signal received from the sensor such that the electrical generator operates within a predetermined range of rotational velocities.

22. The apparatus of claim 20, wherein the controller is further capable of preventing rotation of the electrical generator according to the signal received from the sensor.

23. The apparatus of claim 20, wherein the rotor assembly further comprises a pitch control mechanism electrically coupled to the controller and the controller is further capable of controlling a pitch of the rotor assembly according to the signal received from the sensor.

24. The apparatus of claim 19, wherein:
the rotor assembly, CVT, electrical generator, and sensor are mounted on a platform; and
the platform is capable of rotation about a substantially vertical axis in response to a change in wind direction.

25. The apparatus of claim 24, wherein:
the first one of the plurality of sections further comprises a second rotor assembly, CVT and electrical generator mounted on the platform;
the second CVT is communicatively coupled to the sensor and is further capable of adjusting its operation according to the sensed characteristic.
